(19) United States
(12) Patent Application Publication
(10) Pub. No.: US 2014/0082484 A1
(43) Pub. Date: Mar. 20, 2014

(54) METHOD AND APPARATUS FOR OBTAINING INFORMATION

(71) Applicant: Tencent Technology (Shenzhen) Company Limited, Shenzhen (CN)

(72) Inventors: ZIXIN HAN, Shenzhen (CN); GUOQIANG WANG, Shenzhen (CN); ZHAN CHEN, Shenzhen (CN); SHUICHENG HUANG, Shenzhen (CN); PENG SUN, Shenzhen (CN)

(73) Assignee: Tencent Technology (Shenzhen) Company Limited, Shenzhen (CN)

(21) Appl. No.: 14/082,510

(22) Filed: Nov. 18, 2013

Related U.S. Application Data
(63) Continuation of application No. PCT/CN2013/083508, filed on Sep. 13, 2013.

(30) Foreign Application Priority Data
Sep. 20, 2012 (CN) 201210350647.8

(51) Int. Cl. G06F 17/22

(52) U.S. Cl. CPC G06F 17/2247
USPC 715/234

(57) ABSTRACT

A method is provided for obtaining information on the Internet. The method includes an information obtaining apparatus changing from a paging mode to a reading mode of a client. The method also includes the information obtaining apparatus downloading at least two pages of preset webpages when receiving a request for accessing the preset webpages sent from the client. Further, the method includes the information obtaining apparatus extracting body content of the at least two pages of the preset webpages. The method includes the information obtaining apparatus splicing and outputting the body content of the preset webpages in a predetermined sequence.

### CROSS-REFERENCES TO RELATED APPLICATIONS

This application is a continuation of PCT Patent Application No. PCT/CN2013/083508, filed on Sep. 13, 2013, which claims priority of Chinese Patent Application No. 201210350647.8, filed on Sep. 20, 2012, the entire contents of all of which are incorporated by reference herein.

### FIELD OF THE INVENTION

The present invention generally relates to computer network technologies and, more particularly, to an information obtaining method and apparatus.

### BACKGROUND

With the rapid development of mobile terminals, browsers are becoming one important entry of mobile Internet. More and more users use mobile browser to read novels or view pictures. However, webpages for continuous reading in the browser are stored in separate pages, i.e., a paging mode, and spacing between adjacent pages is relatively large. A user may need to drag the current webpage over a long distance when the user wants to read the next page. In addition, there is a lot of information that the user does not need to read in many webpages, e.g., advertising, repeated titles, etc. Such information that the user does not need to read further interferes with the user's reading of the content in the webpage body.

The disclosed methods and apparatus are directed to solve one or more problems set forth above and other problems.

### BRIEF SUMMARY OF THE DISCLOSURE

One aspect of the present disclosure includes a method for obtaining information on the Internet. The method includes an information obtaining apparatus changing from a paging mode to a reading mode of a client. The method also includes the information obtaining apparatus downloading at least two pages of preset webpages when receiving a request for accessing the preset webpages sent from the client. Further, the method includes the information obtaining apparatus extracting body content of the at least two pages of the preset webpages. The method includes the information obtaining apparatus splicing and outputting the body content of the preset webpages in a predetermined sequence.

Another aspect of the present disclosure includes an information obtaining apparatus. The information obtaining apparatus includes a downloading module, an extraction module, and an output module. The downloading module is configured to download at least two pages of preset webpages when receiving a request for accessing the preset webpages sent from a client. The extraction module is configured to extract body content of at least two pages of the preset webpages. Further, the output module is configured to splice and output the body content of the preset webpages in a predetermined sequence.

Other aspects of the present disclosure can be understood by those skilled in the art in light of the description, the claims, and the drawings of the present disclosure.

### BRIEF DESCRIPTION OF THE DRAWINGS

In order to more clearly illustrate technical solutions of the present invention or the existing technology, the figures which are needed to be used in the description of the present invention or the existing technology are briefly described in the following. Obviously, the figures in the following description are only some embodiments of the present invention, and it is easily for those skilled in the art to obtain other figures based on the following figures without creative work.

FIG. 1 illustrates a flow diagram of an exemplary information obtaining method consistent with the disclosed embodiments;

FIG. 2 illustrates a flow diagram of another exemplary information obtaining method consistent with the disclosed embodiments;

FIG. 3 illustrates a structure diagram of an exemplary information obtaining apparatus consistent with the disclosed embodiments;

FIG. 4 illustrates a structure diagram of another exemplary information obtaining apparatus consistent with the disclosed embodiments;

FIG. 5 illustrates an exemplary operating environment incorporating certain disclosed embodiments; and

FIG. 6 illustrates a block diagram of an exemplary computer system consistent with the disclosed embodiments.

### DETAILED DESCRIPTION

Reference will now be made in detail to exemplary embodiments of the invention, which are illustrated in the accompanying drawings.

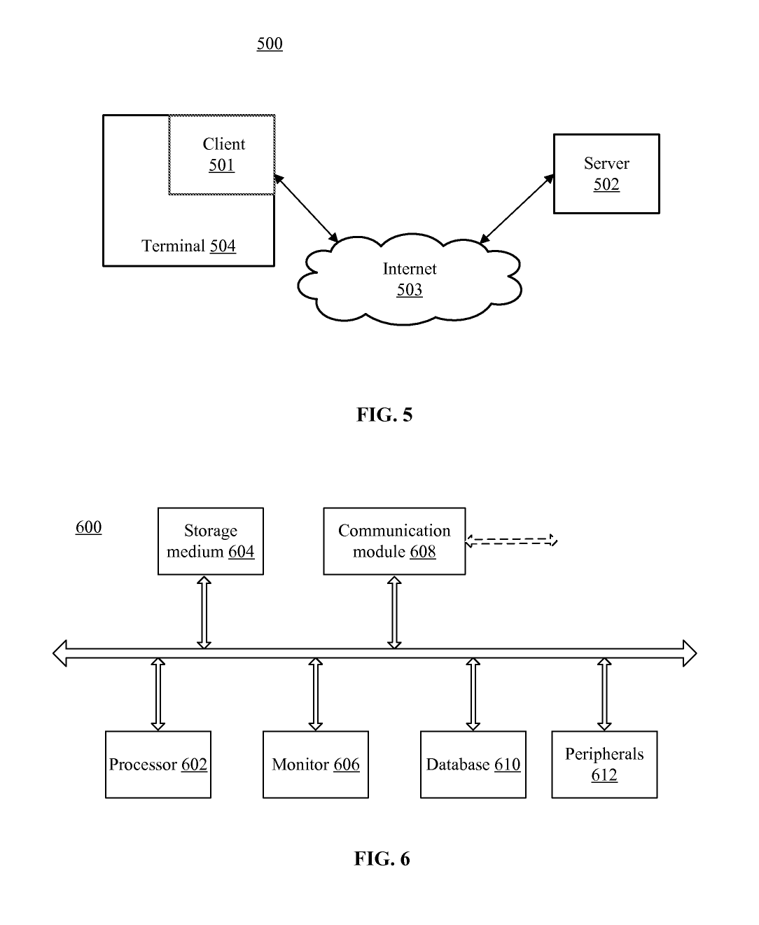

FIG. 5 illustrates an exemplary operating environment 500 incorporating certain disclosed embodiments. As shown in FIG. 5, environment 500 may include a terminal 504, the Internet 503, and a server 502. The Internet 503 may include any appropriate type of communication network for providing network connections to the terminal 504 and the server 502 or among multiple terminals and servers. For example, Internet 503 may include the Internet or other types of computer networks or telecommunication networks, either wired or wireless.

A server, as used herein, may refer to one or more server computers configured to provide certain web server functionalities to provide certain personalized services, which may require any user accessing the services to authenticate to the server before the access. A web server may also include one or more processors to execute computer programs in parallel.

The server 502 may include any appropriate server computers configured to provide certain server functionalities, such as a file server functionality for responding a user's request for obtaining information operations or other application server. Although only one server is shown, any number of servers can be included. The server 502 may be operated in a cloud or non-cloud computing environment.

Terminal 504 may include any appropriate type of mobile computing devices, such as mobile phones, smart phones, tablets, notebook computers, or any type of computing platform. A terminal (e.g., terminal 504) may include one or more clients 501. The client 501, as used herein, may include any appropriate mobile application software, hardware, or a combination of application software and hardware to achieve certain client functionalities. For example, client 501 may include a browser, etc. According to actual needs in different terminals, a mobile client may be a browser installed on the terminal for browsing, including various types of existing and future browser installed on terminals. Although only one client 501 is shown in the environment 500, any number of clients 501 may be included.

Terminal 504, client 501, and/or server 502 may be implemented on any appropriate computing platform. FIG. 6 illustrates a block diagram of an exemplary computer system 600 capable of implementing terminal 504, client 501, and/or server 502.

As shown in FIG. 6, computer system 600 may include a processor 602, a storage medium 604, a monitor 606, a communication module 608, a database 610, and peripherals 612. Certain devices may be omitted and other devices may be included.

Processor 602 may include any appropriate processor or processors. Further, processor 602 can include multiple cores for multi-thread or parallel processing. Storage medium 604 may include memory modules, such as Read-only memory (ROM), Random Access Memory (RAM), flash memory modules, and erasable and rewritable memory, and mass storages, such as CD-ROM, U-disk, and hard disk, etc. Storage medium 604 may store computer programs for implementing various processes, when executed by processor 602.

Further, peripherals 612 may include I/O devices such as keyboard and mouse, and communication module 608 may include network devices for establishing connections through the communication network. Database 610 may include one or more databases for storing certain data and for performing certain operations on the stored data, such as database searching.

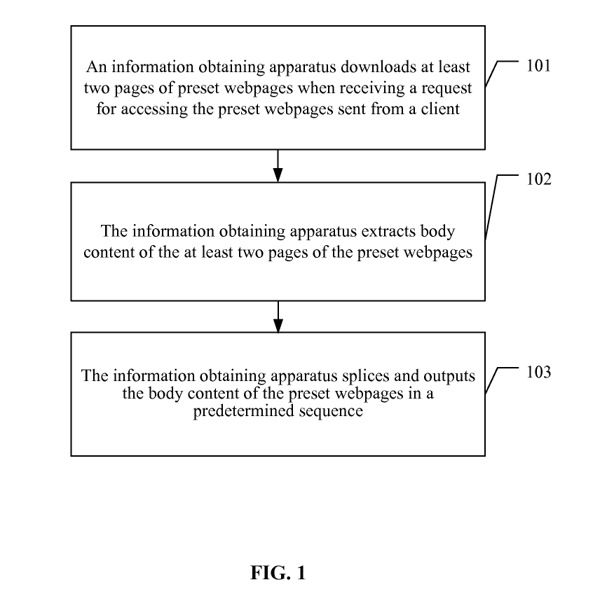

In operation, terminals/clients and servers 502 may interact with each other to provide an information obtaining service to the user(s) of the terminals. FIG. 1 illustrates a flow diagram of an exemplary information obtaining process consistent with the disclosed embodiments.

As shown in FIG. 1, the information obtaining process includes the following steps:

Step 101: an information obtaining apparatus downloads at least two pages of preset webpages when receiving a request for accessing the preset webpages sent from a client.

Step 102: the information obtaining apparatus extracts body content of the at least two pages of the preset webpages.

Step 103: the information obtaining apparatus splices and outputs the body content of the preset webpages in a predetermined sequence.

Before the information obtaining apparatus downloads at least two pages of preset webpages, the information obtaining apparatus may also determine the total number of the preset webpages to be downloaded.

More specifically, when determining the number of the preset webpages to be downloaded, the information obtaining apparatus may obtain access point information of the client and, based on the access point information of the client, the information obtaining apparatus judges whether network access of the client is charged according to traffic amount. If the network access of the client is not charged according to traffic, the information obtaining apparatus determines to download the first number of preset pages of the preset webpages; if the network access of the client is charged according to traffic, the information obtaining apparatus determines to download the second number of preset pages of the preset webpages.

Optionally, when the network access of the client is not charged according to traffic, and after the information obtaining apparatus splices and outputs the body content of the preset webpages in a predetermined sequence, the information obtaining process further includes that, when receiving a request for displaying the next page from the client, the information obtaining apparatus downloads the webpages after the first preset pages.

Further, when the access type of the client is charged according to traffic, after the information obtaining apparatus splices and outputs the body content of the preset webpages in a predetermined sequence, the information obtaining process further includes:

The information obtaining apparatus obtains the total number of spliced pages of the current page cached on the client and judges whether the number of the spliced pages exceeds a threshold value. If the number of the spliced pages exceeds the threshold value, the information obtaining apparatus discards certain webpages (e.g., designated webpages) of the current page and downloads webpages after the second number of preset pages.

In addition, when extracting body content of at least two pages of the preset webpages, the information obtaining apparatus may trims non-body content information of the downloaded webpages and reformats the trimmed body content as pure document or pure text to obtain the body content of the preset webpages.

Therefore, the information obtaining apparatus downloads at least two pages of the preset webpages when receiving a request for accessing the preset webpages sent from the client. Then, the information obtaining apparatus extracts body content of at least two pages of the preset webpages. The information obtaining apparatus splices and outputs the body content of the preset webpages in the predetermined sequence. That is, when the client receives an access request from a user, the information obtaining apparatus downloads body content of at least two pages of the preset webpages. Then, the information obtaining apparatus splices and outputs the downloaded content as pure text in a clean, clutter-free format. Therefore, the user may browse webpages more conveniently when using the mobile terminal without interference from non-body content information, improving the user's reading experience.

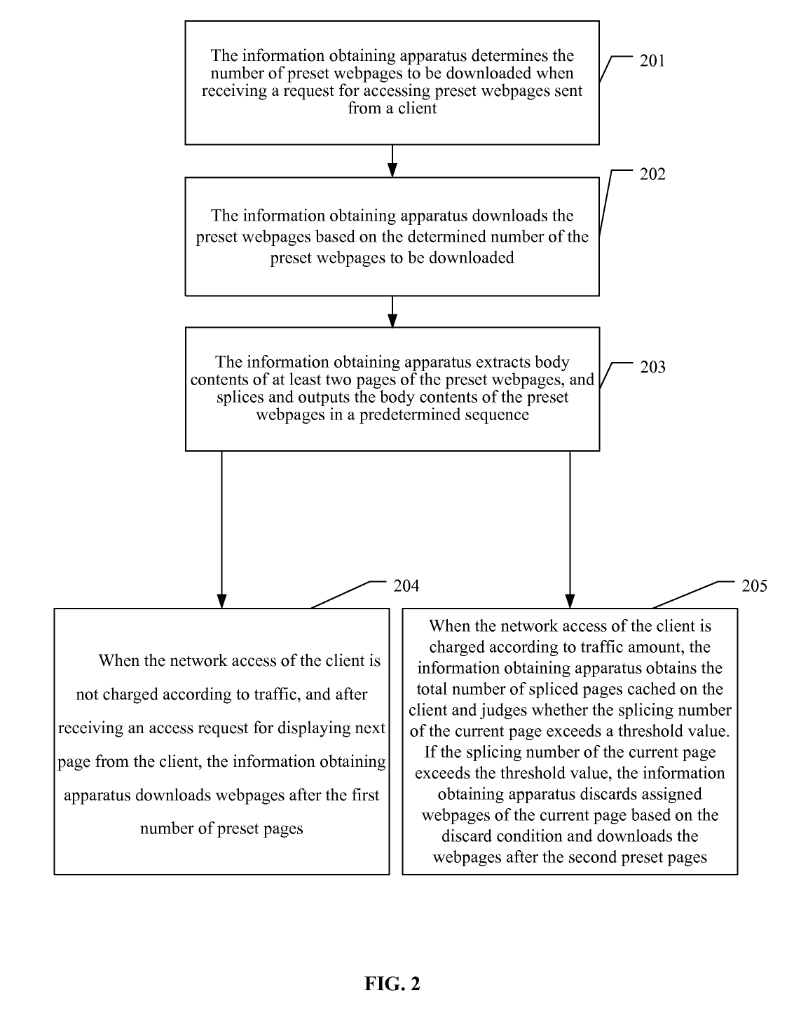

FIG. 2 illustrates a flow diagram of another exemplary information obtaining process consistent with the disclosed embodiments.

A preset browser (i.e., a client) is provided for the user of the terminal. When a user uses the preset browser (e.g., a mobile browser) to read novels or view pictures on a terminal screen, a reading mode is provided for the user. Under the provided reading mode, when the user uses the preset browser to read lengthy graphic and text information, such as novels, the information obtaining apparatus automatically downloads webpages that the user may read, via intelligent judgment, and splices the previous page and the next page together in a layout similar to reading layout, allowing the user to enter an immersive reading state.

As described, the terminal may include any appropriate type of mobile computing devices, such as mobile phones, smart phones, tablets, notebook computers, or any type of computing platform. The client, as used herein, may include any appropriate mobile application software, hardware, or a combination of application software and hardware to achieve certain client functionalities. There are no specific limitations on the client, and the information obtaining apparatus may refer to either or both of the terminal and the client.

In practical applications, according to different types of network access of the client, a fast-reading mode and a traffic-saving reading mode are provided in the browser for the users. If the network access of the client is not charged according to actual traffic, the fast-reading mode may be selected. Under the fast-reading mode, because the network environment is relatively good, when receiving an access request from the client, the information obtaining apparatus may download more network contents.

For example, the information obtaining apparatus may download and parse the first number of preset webpages. After the first number of preset webpages are parsed, the parsed webpages are stored in the cache and put on a display list to wait for being displayed. For example, if the first number of preset webpages is N, N pages of webpages are downloaded successively, and the downloaded webpages are parsed and cached in a display list.

Further, although the (N+1)th page is not parsed, the source code of (N+1)th page may be stored in the (N+1)th space in the cache. When receiving a request for displaying the next page from the client/user, the content of the (N+1)th page is downloaded, and the downloaded webpage content is parsed and put on the display list. Thus, the next page content may be displayed by local parsing operation, thereby avoiding the time spent in waiting for requesting the network to receive data again.

The network environment that is not charged according to actual traffic may include, but not limited to, WiFi, LAN, etc. The first number of the preset webpages may be 2, 3, 5, etc., and the information obtaining apparatus may determine the first number based on user configuration or based on particular applications. Further, the information obtaining apparatus may adjust the first number based on the network environment. For example, the first number of the preset pages may be set to 5 in a desired network environment, or the first number of the preset pages may be set to 3 in a less-desired network environment.

If the network access of the client is charged according to actual traffic, the traffic-saving reading mode is selected. Under the traffic-saving reading mode, in order to save the traffic generated by the client, when receiving an access request from the client, the information obtaining apparatus may download the second number of preset webpages. The second number may be 2, 3, etc., and the information obtaining apparatus may adjust the second number of the preset pages based on traffic charge of the client. The network environment that is charged according to actual traffic may include General Packet Radio Service (GPRS) or other wireless networks, etc.

Further, under the traffic-saving reading mode, only page information currently displayed is cached, and there is no (N+1)th unparsed page downloaded and stored in the (N+1)th space. When a discard condition is satisfied, the information obtaining apparatus discards an old page and downloads and parses the (N+1)th page to be displayed.

The discard condition may be based on the total number of spliced pages, i.e., the total pages reformatted by removing page spacing and other non-body content, which may be set to a threshold value and may be adjusted dynamically based on the available cache and/or the network access condition. If the spliced page number reaches the threshold value, the oldest page (e.g., the most front page) may be discarded and the new page can be downloaded, parsed, and displayed.

More particularly, as shown in FIG. 2, the information obtaining process includes the following steps:

Step 201: the information obtaining apparatus determines the number of preset webpages to be downloaded when receiving a request for accessing preset webpages sent from a client.

Before downloading the preset webpages, based on the current network access type of the client, the information obtaining apparatus determines the number of the preset webpages to be downloaded. More specifically, to determine the number of the preset webpages to be downloaded, the information obtaining apparatus may first obtain access point information of the client.

Based on the access point information of the client, the information obtaining apparatus judges whether the network access of the client is charged according to traffic. If the network access of the client is not charged according to traffic, the information obtaining apparatus determines to download the first number of preset webpages from the preset webpages. On the other hand, if the network access of the client is charged according to traffic, the information obtaining apparatus determines to download the second number of preset pages from the preset webpages.

Specifically, when the client uses the preset browser, the webpages are opened according to a current operating mode, i.e., the paging mode. A ‘reading mode’ option button may be provided on the displayed pages under the paging mode for the user to change the paging mode into the ‘reading mode.’ If a user selects the ‘reading mode’ button, the ‘reading mode’ is used in the preset browser of the client. If the user does not select the ‘reading mode’ button, the default paging mode is used by the user, that is, the next page content is obtained by clicking ‘next page’ every time. Of course, the reading mode may be selected by other methods.

Step 202: the information obtaining apparatus downloads the preset webpages based on the determined number of the preset webpages to be downloaded.

For example, when the network access type of the client is WiFi access, the information obtaining apparatus determines the number of the webpages to be downloaded as the first preset page number and downloads the preset webpages based on the first preset page number. When the network access type of the client is GPRS access, the information obtaining apparatus determines the number of the webpages to be downloaded as the second preset page number and downloads the preset webpages based on the second preset page number.

More specifically, when downloading the preset webpages based on the determined number of the preset webpages to be downloaded, the information obtaining apparatus downloads in order and parses a first page content of the webpages to be downloaded. Further, the information obtaining apparatus judges whether the number of pages of the downloaded webpages matches the number of the webpages that are determined to be downloaded.

If there is a match, the step of downloading the preset webpages is paused. Otherwise, keywords of the first page are searched, and then the information obtaining apparatus downloads and parses a second page based on the keywords. Such matching/downloading is repeated until all webpages to be downloaded are downloaded.

For example, after determining the number of the webpages to be downloaded, the information obtaining apparatus automatically searches the keywords of the webpages and automatically downloads the linked content corresponding to the keywords. The keywords may include ‘Next Page’, page number, or similar words or phrases, etc. For instance, if the number of webpages to be downloaded is 5, the first page is downloaded and parsed first. Then the information obtaining apparatus searches the keywords in the first page. If the keyword in the first page is ‘Next Page’, the information obtaining apparatus automatically downloads and parses the linked content corresponding to ‘next page,’ which is the second page. The downloading process can be repeated until the fifth page content is downloaded.

Step 203: the information obtaining apparatus extracts body contents of at least two pages of the preset webpages, and splices and outputs the body contents of the preset webpages in a predetermined sequence.

To improve the user's reading experience, the information obtaining apparatus extracts body content of at least two pages of the preset webpages, and splices and outputs the body content of the preset webpages in a predetermined sequence. Therefore, the user may browse webpages more conveniently without interference from non-body content information, enjoying an immersive reading status. The body content includes, but not limited to, images, text, or videos.

Specifically, when extracting body content of at least two pages of the preset webpages, the information obtaining apparatus trims non-body content information of the downloaded webpages and reformats the trimmed body content as pure contents to obtain body content of the preset webpages. The non-body content information includes, but not limited to, page header, footer, advertising information, etc. The body content is reformatted as plain text which is similar to book text style, or as other content formats, as long as the non-body contents of the pages can be removed and the remaining contents are reformatted or republished such that the effects of the non-body contents are no longer visible.

Further, spacing among pages may also be removed or adjusted. For example, the information obtaining apparatus may remove the spacing between the pages such that the user can read the reformatted contents without any page separation for continuous content reading. Or the spacing between the pages may be adjusted to fit the terminal screen used by the user to view the contents. Thus, pure text contents can be displayed for the user, improving the user's reading experience.

In addition, the information obtaining apparatus may determine the network access type of the client so that the reading mode can be further adjusted to fit the user's needs, requirements, or configurations. For example, based on the access point information of the client, the information obtaining apparatus judges whether the network access of the client is charged according to traffic amount.

Step 204: when the network access of the client is not charged according to traffic, and after receiving an access request for displaying next page from the client, the information obtaining apparatus downloads webpages after the first number of preset pages.

For example, when the network access type of the client is WIFI access, after the current page is displayed, the client receives a request for displaying next page content from the user or for displaying more pages from the user, the information obtaining apparatus automatically downloads the content that is not yet downloaded in the preset webpages. The request of displaying a new webpage is triggered automatically after the previous webpage is displayed. Therefore, the user may smoothly browse the webpages by using this method when the network speed is relatively slow.

Step 205: when the network access of the client is charged according to traffic amount, the information obtaining apparatus obtains the total number of spliced pages cached on the client and judges whether the splicing number of the current page exceeds a threshold value. If the splicing number of the current page exceeds the threshold value, the information obtaining apparatus discards assigned webpages of the current page based on the discard condition and downloads the webpages after the second preset pages.

The information obtaining apparatus obtains the splicing number of the current page cached in the client. When the content cached in the client meets the discard condition, the information obtaining apparatus discards the content that meets the discard condition, and downloads and parses the content that has not been downloaded previously from the network request to display the next page.

The discard condition may be based on a preset threshold value. When a threshold value is exceeded, the information obtaining apparatus discards the assigned webpages of the current page. The threshold value may be a fixed value. The threshold value may also be dynamically adjusted based on the current remaining memory and/or network condition. The assigned webpages may be the first one or more pages of the current webpage.

Thus, the information obtaining apparatus downloads at least two pages of the preset webpages when receiving a request for accessing the preset webpages sent from the client. Then, the information obtaining apparatus extracts body content of at least two pages of the preset webpages. The information obtaining apparatus splices and outputs the body content of the preset webpages in a predetermined sequence. That is, when the client receives an access request from a user, the information obtaining apparatus downloads body content of at least two pages of the preset webpages. Then, the information obtaining apparatus splices and outputs the downloaded content in a clean, clutter-free format. Therefore, the user may browse webpages more conveniently without interference from non-body content information, improving the user's reading experience. Further, the next page is obtained without having to click next page link every time by the user, reducing the user's operation and time waiting for the Internet response after each clicking of next page, and further improving the user's reading experience.

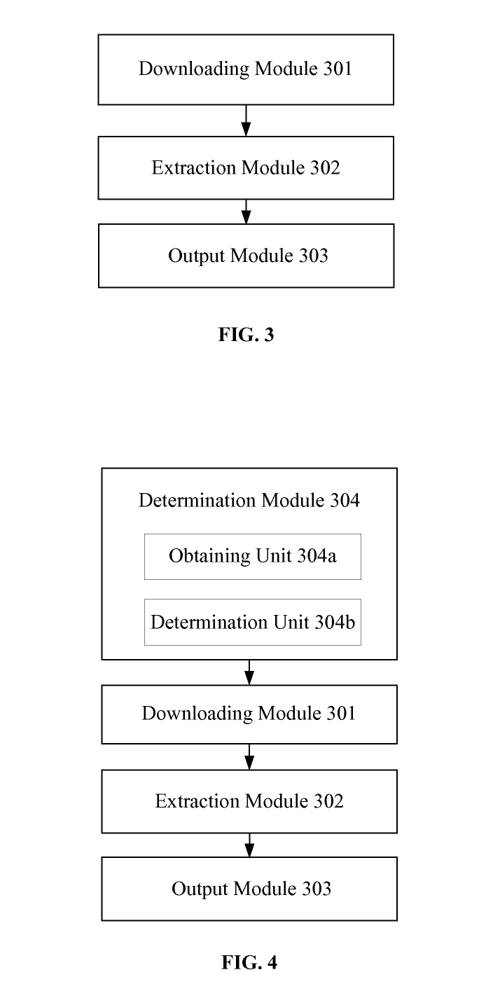

FIG. 3 illustrates a structure diagram of an exemplary information obtaining apparatus consistent with the disclosed embodiments. As shown in FIG. 3, the information obtaining apparatus includes a downloading module 301, an extraction module 302, and an output module 303.

The downloading module 301 is configured to download at least two pages of preset webpages when receiving a request for accessing the preset webpages sent from a client. The extraction module 302 is configured to extract body content of at least two pages of the preset webpages. The output module 303 is configured to splice and output the body content of the preset webpages in a predetermined sequence.

FIG. 4 illustrates a structure diagram of another exemplary information obtaining apparatus consistent with the disclosed embodiments. As shown in FIG. 4, the information obtaining apparatus also includes a determination module 304, in addition to downloading module 301, extraction module 302, and output module 303.

The determination module 304 is configured to determine the number of preset webpages to be downloaded before downloading at least two pages of preset webpages. The determination module 304 may further include an obtaining unit 304a and a determination unit 304b.

The obtaining unit 304a is configured to obtain access point information of the client. The determination unit 304b is configured to judge whether the network access of the client is charged according to traffic amount, based on the access point information of the client. If the network access of the client is not charged according to traffic amount, the determination module determines to download the first number of preset pages from the preset webpages; if the network access of the client is charged according to traffic amount, the determination module determines to download the second number of preset pages from the preset webpages.

In addition, when the network access of the client is not charged according to traffic amount, after the output module 303 splices and outputs the body content of the preset webpages in a predetermined sequence, the downloading module 301 is also configured to download the webpages after the first number of preset pages when receiving a request for displaying the next page from the client.

When the network access of the client is charged according to traffic amount, after the output module 303 splices and outputs the body content of the preset webpages in a predetermined sequence, the downloading module 301 is also configured to obtain the splicing number of the current page cached on the client and judges whether the splicing number of the current page exceeds a threshold value. If the splicing number of the current page exceeds the threshold value, the downloading module 301 discards the assigned webpages of the current page and downloads the webpages after the second number of preset pages.

The extraction module 302 is further configured to trim non-body content information of the downloaded webpages and reformat or republish the trimmed body content to obtain body content of the preset webpages.

It should be noted that, in the above server and terminal device for obtaining information, each functional module is listed only for illustrative purposes. In practical applications, the above functions are implemented by different functional modules according to the needs. That is, the internal structure of the device for obtaining information is divided into different functional modules to complete all or part of the functions described above.

Those skilled in the art should understand that all or part of the steps in the above method may be executed by relevant hardware instructed by a program, and the program may be stored in a computer-readable storage medium such as a read only memory, a magnetic disk, a Compact Disc (CD), and so on.

The embodiments disclosed herein are exemplary only and not limiting the scope of this disclosure. Without departing from the spirit and scope of this invention, other modifications, equivalents, or improvements to the disclosed embodiments are obvious to those skilled in the art and are intended to be encompassed within the scope of the present disclosure.

### INDUSTRIAL APPLICABILITY AND ADVANTAGEOUS EFFECTS

Without limiting the scope of any claim and/or the specification, examples of industrial applicability and certain advantageous effects of the disclosed embodiments are listed for illustrative purposes. Various alternations, modifications, or equivalents to the technical solutions of the disclosed embodiments can be obvious to those skilled in the art and can be included in this disclosure.

By using the disclosed methods and apparatus for obtaining information, thus, the information obtaining apparatus downloads at least two pages of the preset webpages when receiving a request for accessing the preset webpages sent from the client. Then, the information obtaining apparatus extracts body content of at least two pages of the preset webpages. The information obtaining apparatus splices and outputs the body content of the preset webpages in a predetermined sequence. That is, when the client receives an access request from a user, the information obtaining apparatus downloads body content of at least two pages of the preset webpages. Then, the information obtaining apparatus splices and outputs the downloaded content in a clean, clutter-free format. Therefore, the user may browse webpages more conveniently without interference from non-body content information, improving the user's reading experience. Further, the next page is obtained without having to click next page link every time by the user, reducing the user's operation and time waiting for the Internet response after each clicking of next page, and further improving the user's reading experience.

What is claimed is:

1. A method for obtaining information, comprising:
changing from a paging mode to a reading mode of a client;
downloading, by an information obtaining apparatus, at least two pages of preset webpages when receiving a request for accessing the preset webpages sent from the client;
extracting, by the information obtaining apparatus, body content of the at least two pages of the preset webpages; and
splicing and outputting, by the information obtaining apparatus, the body content of the preset webpages in a predetermined sequence.

2. The method according to claim 1, before downloading at least two pages of preset webpages, further including:
determining, by the information obtaining apparatus, a number of the preset webpages to be downloaded.

3. The method according to claim 2, wherein determining the number of the preset webpages to be downloaded further includes:
obtaining, by the information obtaining apparatus, access point information of the client; and
determining, by the information obtaining apparatus and based on the access point information of the client, whether network access of the client is charged according to traffic amount,
when it is determined that the network access of the client is not charged according to traffic amount, using a fast-reading mode to download the preset webpages; and
when it is determined that the network access of the client is charged according to traffic amount, using a traffic-saving reading mode to download the preset webpages.

4. The method according to claim 3, wherein using the fast-reading mode and the traffic-saving reading mode further includes:
when the network access of the client is not charged according to traffic amount, the information obtaining apparatus determines to download a first number of preset pages from the preset webpages; and
when the network access of the client is charged according to traffic amount, the information obtaining apparatus determines to download a second number of preset pages from the preset webpages.

5. The method according to claim 3, wherein, under the fast-reading mode and provided that the first number of preset pages is N, the method further includes:
parsing and storing the N number of downloaded pages in a cache;
putting the N number of downloaded pages on a display list; and
downloading, without parsing, a (N+1)th webpage in a (N+1) space in the cache without putting the (N+1)th page on the display list.

6. The method according to claim 4, when the network access of the client is not charged according to traffic amount, after splicing and outputting the body content of the preset webpages in a predetermined sequence, further including:
downloading, by the information obtaining apparatus, webpages after the first number of preset pages when receiving a request for displaying a next page from the client.

7. The method according to claim 4, when the network access of the client is charged according to traffic amount, after splicing and outputting the body content of the preset webpages in a predetermined sequence, further including:
obtaining, by the information obtaining apparatus, a number of spliced pages of the current page cached on the client; and
judging, by the information obtaining apparatus, whether the number of spliced pages of the current page exceeds a threshold value, wherein:
when the number of spliced pages of the current page exceeds the threshold value, the information obtaining apparatus discards assigned webpages of the current page and downloads a webpage after the second number of preset pages.

8. The method according to claim 1, wherein extracting body content of at least two pages of the preset webpages further includes:
trimming non-body content information of the downloaded preset webpages; and
republishing the trimmed content to create body content of the preset webpages.

9. The method according to claim 8, wherein extracting body content of at least two pages of the preset webpages further includes:
removing at least page header, footer, and advertising information from the downloaded preset webpages to obtain the trimmed content; and
removing page spacing from the downloaded preset webpages such that contents of the downloaded preset webpages are displayed continuously.

10. The method according to claim 1, wherein changing from a paging mode to a reading mode of a client further includes:
receiving a user selection from a reading mode button on a webpage displayed; and
changing the paging mode to the reading mode based on the user selection.

11. A apparatus for obtaining information, comprising:
a downloading module configured to download at least two pages of preset webpages when receiving a request for accessing the preset webpages sent from a client;
an extraction module configured to extract body content of at least two pages of the preset webpages; and
an output module configured to splice and output the body content of the preset webpages in a predetermined sequence.

12. The apparatus according to claim 11, further including:
a determination module configured to determine a number of the preset webpages to be downloaded before downloading at least two pages of the preset webpages.

13. The apparatus according to claim 12, wherein the determination module further includes:
an obtaining unit configured to obtain access point information of the client; and
a determination unit configured to determine whether the network access of the client is charged according to traffic amount, based on the access point information of the client,
when it is determined that the network access of the client is not charged according to traffic amount, to use a fast-reading mode to download the preset webpages; and
when it is determined that the network access of the client is charged according to traffic amount, to use a traffic-saving reading mode to download the preset webpages.

14. The apparatus according to claim 13, wherein:
when the network access of the client is not charged according to traffic amount, the determination unit determines to download a first number of preset pages from the preset webpages; and
when the network access of the client is charged according to traffic amount, the determination unit determines to download a second number of preset pages from the preset webpages.

15. The apparatus according to claim 13, wherein, under the fast-reading mode and provided that the first number of preset pages is N, the information obtaining apparatus is further configured to:
parse and store the N number of downloaded pages in a cache;
put the N number of downloaded pages on a display list; and
download, without parsing, a (N+1)th webpage in a (N+1) space in the cache without putting the (N+1)th page on the display list.

16. The apparatus according to claim 14, wherein, when the network access of the client is not charged according to traffic amount, after the output module splices and outputs the body content of the preset webpages in a predetermined sequence, the downloading module is configured to:
download webpages after the first number of preset pages when receiving a request for displaying a next page from the client.

17. The apparatus according to claim 14, wherein, when the network access of the client is charged according to traffic amount, after the output module splices and outputs the body content of the preset webpages in a predetermined sequence, the downloading module is also configured to:
obtain a number of spliced pages of the current page cached on the client; and
judge whether the number of spliced pages of the current page exceeds a threshold value, wherein:
when the number of spliced pages of the current page exceeds the threshold value, the downloading module discards assigned webpages of the current page and downloads a webpage after the second number of preset pages.

18. The apparatus according to claim 11, wherein the extraction module is further configured to:
trim non-body content information of the downloaded preset webpages; and
republish the trimmed content to create body content of the preset webpages.

19. The apparatus according to claim 18, wherein the extraction module is further configured to:
remove at least page header, footer, and advertising information from the downloaded preset webpages to obtain the trimmed content; and
remove page spacing from the downloaded preset webpages such that contents of the downloaded preset webpages are displayed continuously.

20. The apparatus according to claim 11, wherein the information obtaining apparatus is further configured to:
receive a user selection from a reading mode button on a webpage displayed; and
change a paging mode to a reading mode based on the user selection.
